(19) United States
(12) Patent Application Publication
(10) Pub. No.: US 2011/0046925 A1
(43) Pub. Date: Feb. 24, 2011

(54) Process for Calibrating the Position of a Multiply Articulated System Such as a Robot

(75) Inventors: Catherine Bidard, Strasbourg (FR); Joe Chalfoun, Gaithersburg, MD (US); Delphine Keller, Pierrevert (FR); Yann Perrot, Sainte Genevieve des Bois (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Commissariat a L'Energie Atomique, Paris (FR)

(21) Appl. No.: 12/664,515

(22) PCT Filed: Jun. 12, 2008
(86) PCT No.: PCT/EP08/57415

§ 371 Date: Nov. 5, 2010

(30) Foreign Application Priority Data
Jun. 15, 2007 (FR) 0704286

(51) Int. Cl. G06F 17/16

(52) U.S. Cl. 703/2

(57) ABSTRACT

The present invention relates to a method of calibrating the position of a multiply-articulated system, notably a robot. The multiply-articulated system consisting of a chain of N segments interlinked by an articulated link, the calibration minimizing the difference between the measured position Xₘ of a member linked to the last segment of the chain and its calculated position X_{C}, X_{C} being equal to the product A₁.A₂ . . . Aᵢ . . . A_{N}.X_{N}, a homogeneous transformation matrix Aᵢ being associated with each segment of order i, this matrix being a function of configuration parameters of the system and of given generalized parameters characterizing the flexibility of the segment, the method comprises: a first step of calculating a flexible model of the system consisting of the matrices A₁, A₂ . . . Aᵢ . . . A_{N}; a second step of calibrating the flexible model by obtaining a set of generalized parameters minimizing the difference between Xₘ and X_{C}; a third step of generalized polynomial calibration of the flexible model by the introduction of generalized error matrices Eᵢ between the homogeneous transformation matrices in the flexible model, the calculated position X_{C} being equal to the product A₁.E₁.A₂.E₂ . . . A_{N}.E_{N}.X_{N}, a generalized error matrix Ei being associated with each segment of order i, each matrix Eᵢ of a segment being a polynomial function of the configuration parameters linked to the segment.

The present invention relates to a method of calibrating the position of a multiply-articulated system, notably a robot. It applies in particular to the field of robotics. It makes it possible to correct position error notably on systems of chained multiply-articulated type for which the flexibility of the various elements of the chain influences the behavior, for example in the case of a chain with a strong slenderness ratio. These systems are, for example, robots, manipulators, cranes or machine tools.

These multiply-articulated systems can be used to inspect cells and nuclear reactors and for the maintenance of satellites and spacecraft in space for example.

Hereinafter, the term robot will be used to describe all these systems, whether or not they have a strong slenderness ratio.

Various solutions implement conventional geometrical calibration. These are notably described in the book by B.Mooring entitled “Fundamentals of Manipulator Calibration”, J. Wiley, New York 1991 and the article by Z. S. Roth, Z. W. Mooring and B. Ravani entitled “An Overview of Robot Calibration”, IEEE Journal of Robotics and Automation, vol. 3(5), 1987, pages 377-385. These solutions identify the parameters of the rigid model of the robot, notably the lengths. The position error correction at the end of the chain is very limited with these conventional methods.

Other studies have developed a method of geometrical and linear elastic calibration to regulate the position error on industrial robots. This method is notably described in the article by Ph. Drouet, S. Dubowsky, S. Zeghloul and C. Mavroidis entitled “Compensation of Geometric and Elastic Errors in Large Manipulators with an Application to a High Accuracy Medical System”, Robotica 2, 2002, pages 341-352. However, for robots that have high flexibility in their structure, this method is unsatisfactory.

It is also known to use a generalized linear polynomial model to correct the small position errors of large manipulators. This solution is notably described in the articles by G. Alici and B. Shirinzadeh entitled “A Systematic Technique to Estimate Positioning Errors for Robot Accuracy Improvement Using Laser Interferometry Based Sensing”, Mechanism and Machine Theory 40, 2005, pages 879-906 and by M. Meggiolaro, S. Dubowsky and C. Mavroidis entitled “Geometric and Elastic Error Calibration of a High Accuracy Patient Positioning System”, Mechanism and Machine Theory, vol. 40, 2005, pages 415-427. In the first article, ordinary polynomials and Fourier polynomials are used but the correction is applied only to the last articulation. In the second article, special polynomials are used that are applied to all the articulations of the manipulator. However, by simulating the application of these two methods, notably for a multiply-articulated robot with a strong slenderness ratio, it is not possible to sufficiently correct the position error at the end of the chain.

Another known method consists in producing a flexible modeling of the manipulator with beams, then initiating a procedure to identify the flexible parameters of the model. This method is notably described in the article by W. Khalil and E. Dombre entitled “Modelisation, identification et commande des robots” [Modeling, identifying and controlling robots], Germes, ISBN 2-7462-0003-1, 1999. It gives results that are again insufficient to correct the robot position error. As an example with these methods, for an overall articulated chain length of the order of ten or so meters, position errors of several tens of centimeters are obtained at the end of the chain whereas an accuracy of the order of 10 centimeters is the desired objective.

One aim of the invention is notably to improve accuracy. To this end, the subject of the invention is a method of calibrating the position of a multiply-articulated system consisting of a chain of N segments interlinked by an articulated link, the calibration minimizing the difference between the measured position Xₘ of a member linked to the last segment of the chain and its calculated position X_{C}, X_{C} being equal to the product A₁.A₂ . . . Aᵢ . . . A_{N}.X_{N}, a homogeneous transformation matrix Aᵢ being associated with each segment of order i, this matrix being a function of configuration parameters q of the system and of given generalized parameters p characterizing the flexibility of the segment, said method comprising:
a first step of calculating a flexible model of the system consisting of the matrices A₁, A₂ . . . Aᵢ . . . A_{N};
a second step of calibrating the flexible model by obtaining a set of generalized parameters pₒₚₜ minimizing the difference between Xₘ and X₂;
a third step of generalized polynomial calibration of the flexible model calibrated at the second step by the introduction of generalized error matrices Eᵢ between the homogeneous transformation matrices in the flexible model, the calculated position X_{c} being equal to the product A₁.E₁.A₂.E₂ . . . A_{N}.E_{N}.X_{N}, a generalized error matrix Eᵢ being associated with each segment of order i, each matrix Eᵢ of a segment being a polynomial function of the configuration parameters q linked to the segment.

In a particular embodiment, in the first step, the flexible model of the system is, for example, obtained by the determination of new generalized parameters p from the rigid parameters of the system according to an iterative process:
a geometrical model is calculated as a function of configuration parameters, of original generalized parameters and of geometrical properties of the system;
deformations of the system are calculated as a function of the geometrical model and of mechanical stresses;
new generalized parameters are calculated as a function of the deformations;
the new generalized parameters are compared to the original parameters;
if the difference ΔP between the new parameters and the original parameters is less than a given threshold ε, the flexible model is obtained from the new generalized parameters;
otherwise, a new iteration is executed, this iteration rectifying the model by using the new generalized parameters.
   The mechanical stresses can include flexibility stresses belonging to the generalized parameters p.

The configuration parameters q include, for example, the angles of the rotation axes and of elevation relative to a given reference.

A segment is, for example, modeled by a parallelogram and a rotation axis being articulated between two joints, a first joint belonging to the segment and the second joint belonging to the next segment in the chain, the parallelogram modeling an elevation movement about an axis passing through a peak of the parallelogram, the second being subject to torsion, compression and traction stresses.

A generalized error matrix Eᵢ associated with a segment is, for example, a nonlinear function of six parameters ε₁, ε₂, ε₃, ε₄, ε₄, ε₆, three of these parameters ε₁, ε₂, ε₃ representing the Euler angles corresponding to the rotation movement of a system of coordinates linked to the segment, the other three parameters ε₄, ε₄, ε₆ representing a translation in the space of the center Oᵢ of the system of coordinates, each generalized parameter is a polynomial function of the components of the configuration vector q.

Other characteristics and advantages of the invention will become apparent from the following description, given in light of the appended drawings which represent:

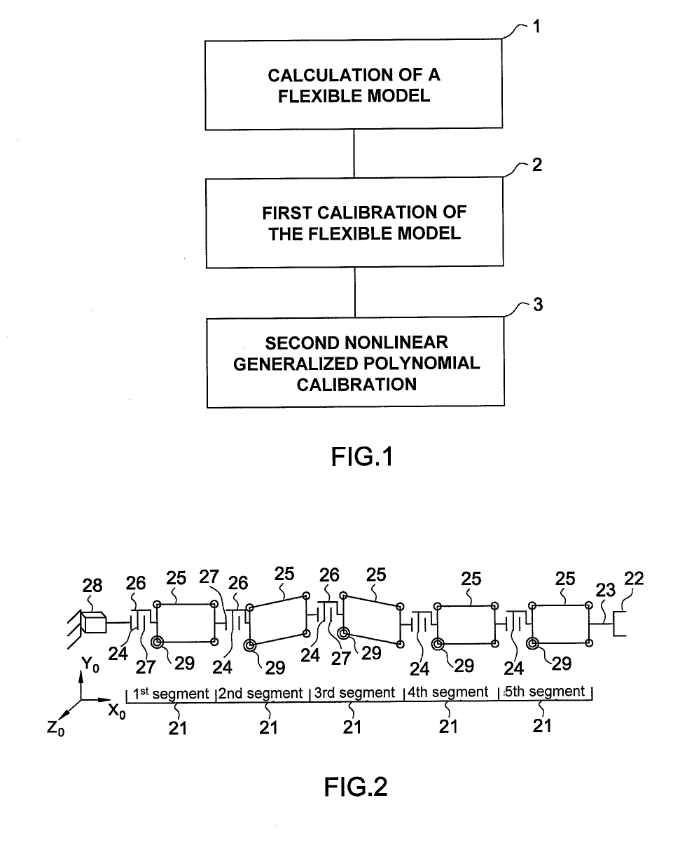

FIG. 1, a presentation of the possible steps for implementing a method according to the invention;

FIG. 2, an exemplary kinematic model of a multiply-articulated system;

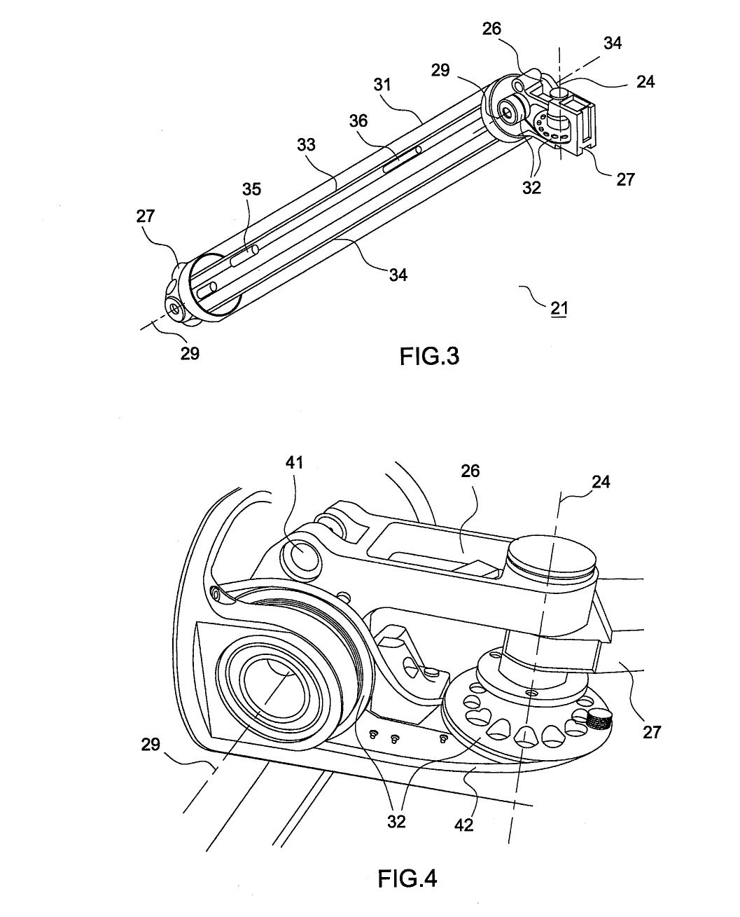

FIG. 3, an exemplary embodiment of a segment belonging to a multiply-articulated chain;

FIG. 4, an exemplary embodiment of an articulation between two segments of a multiply-articulated chain;

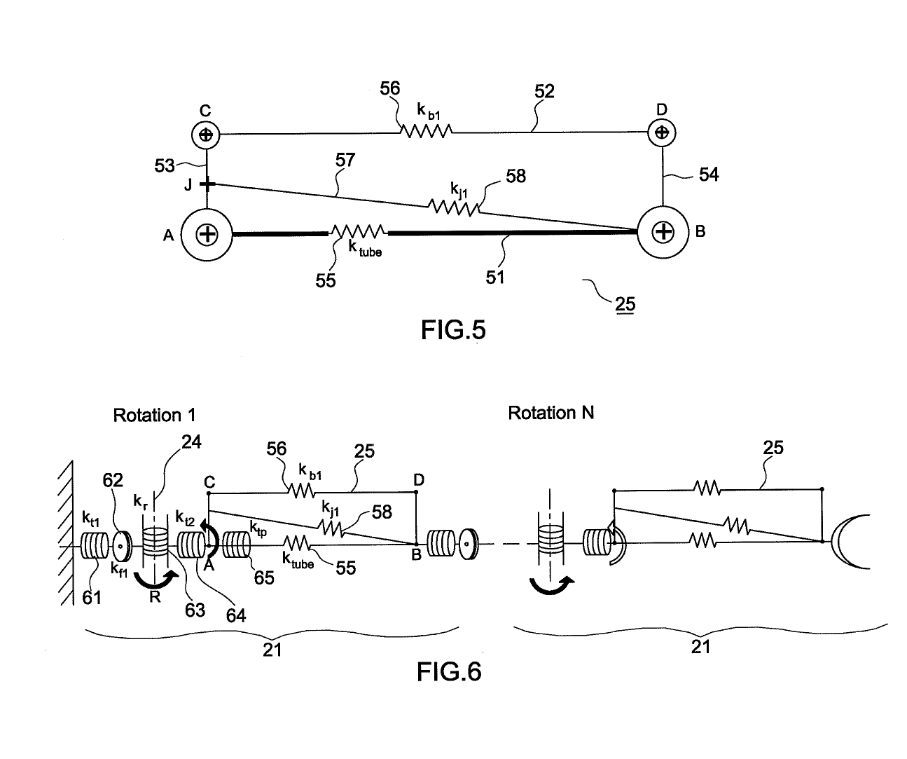

FIG. 5, a parallelogram modeling a segment;

FIG. 6, a flexible model of all of a multiply-articulated system;

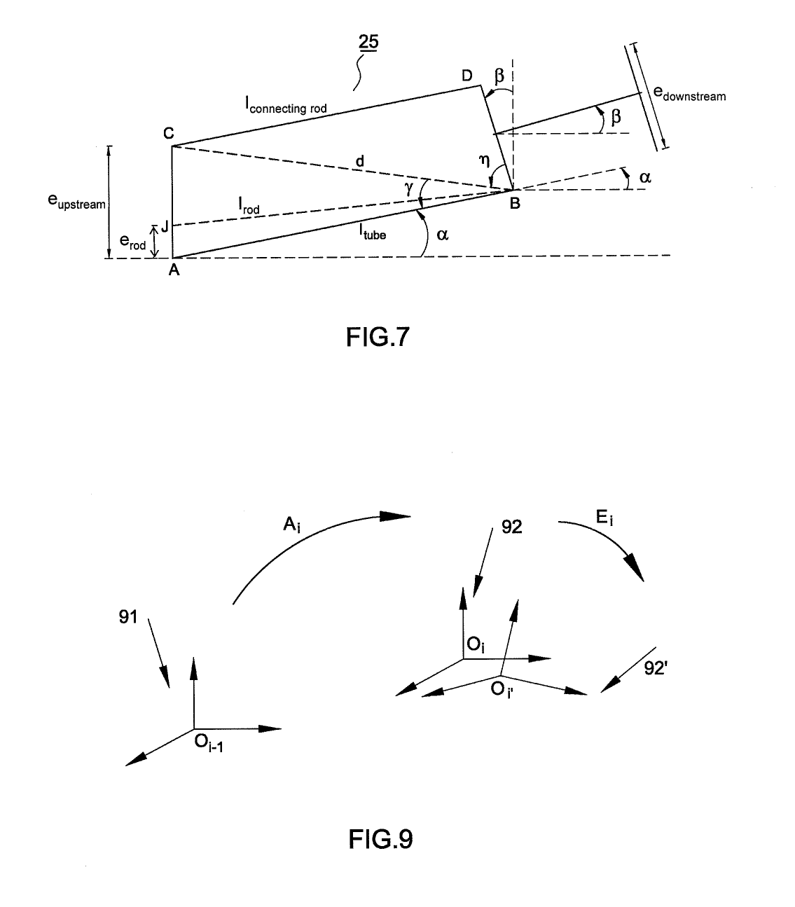

FIG. 7, an illustration of the deformations of a parallelogram structure under the influence of various stresses;

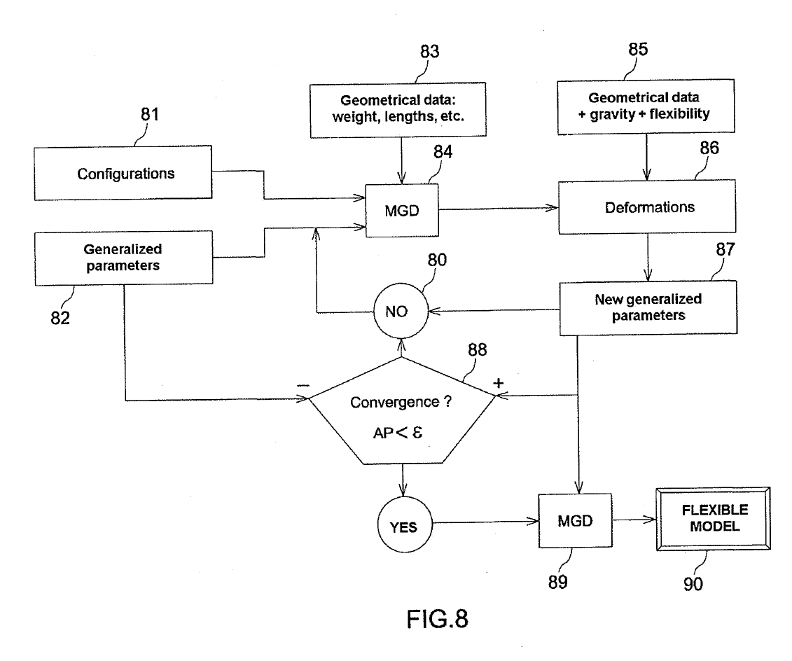

FIG. 8, a presentation of an exemplary iterative process used in the first step of the method according to the invention;

FIG. 9, an illustration of transitions from a system of coordinates linked to a segment to a system of coordinates linked to another segment.

FIG. 1 presents the possible steps for implementing the method according to the invention. In a first step 1, a flexible model of the robot is calculated by determining new generalized parameters from the parameters of the rigid model of the robot. A rigid model is a geometrical model of a multiply-articulated system with no flexibility. A flexible model is a geometrical model of a multiply-articulated system with flexibilities introduced. Generally, a direct geometrical model is a mechanical model used in robotics for manipulator arms notably for multiply-articulated robots. It can be used to determine the configuration, in position and orientation, of the terminal member of a robot as a function of the configuration of its links.

Then, the double calibration is carried out. Thus, in a second step 2, a first calibration of the flexible model is performed, followed in a third step 3 by a generalized polynomial calibration.

FIG. 2 presents, by way of example, a kinematic model of a multiply-articulated robot with a strong slenderness ratio. In this example, the multiply-articulated chain comprises five segments 21. A terminal member 22 is situated at the end of the chain, linked to the last segment. This terminal member 22, or effector, is a tool placed at the end of the robot, which can be a clamp, a camera or any other type of tool dependent on the use of the robot. The link 23 between the effector 22 and the last segment 21 is rigid. In the model of FIG. 2, each segment comprises a rotation axis 24 and a parallelogram 25. A rotation axis 24 is contained between two joints 26, 27, a first joint 26 belonging to the segment itself and a second joint 27 belonging to the preceding segment. This rotation axis 24, combined with the joints, makes it possible to model a rotation movement in a plane X₀, Z₀, for example the horizontal plane. Other types of articulation are possible. The parallelogram makes it possible to model an elevation movement about an axis 29. The first segment of the chain is, for example, linked to a fixed structure 28 by an articulation of the same type as that linking two segments together, this fixed structure 28 forming, for example, the base of the robot to which a fixed system of coordinates can notably be linked.

FIG. 3 presents an exemplary embodiment of a segment 21. This segment comprises a tube 31 comprising, at each end, a joint 26, 27. A first joint 26 is articulated about the joint 27 of the next segment through the intermediary of the rotation axis 24. The rotation movements are obtained by means of rotation pulleys 32 driving a rotation cable. The tube 31 comprises, at each end, an elevation axis 29. It also comprises, inside, a top connecting rod 33 and a bottom connecting rod 34 connected to the joints 26, 27, and an elevation actuator 35 and a rotation actuator 36.

FIG. 4 gives a more detailed illustration of an exemplary embodiment of an articulation between two consecutive segments. More particularly, the first joint 26 is represented as mechanically joined to a pulley 32, the pulley 32 revolving about the elevation axis 29, this first joint being also linked to the connecting rods 33, 34 by a connection 41. The second joint 27 belonging to the next segment is displaced according to a degree of rotation about the axis 24. The other pulley 32 is attached to this axis 24. The rotation cable 42 is driven by the two pulleys 32. The rotation axis 24 and the elevation axis 29 are perpendicular.

A segment is subject to torsion, compression and traction stresses. However, to simplify the complex calculations of the distortions in this structure, the torsion deformations are, for example, relocated and are represented after the elevation axis 29 at the base of a parallelogram 25 modeling the segment. Only the compressions and the tractions in the structure of the parallelogram are, for example, considered. In this way, the parallelogram remains contained within a plane.

FIG. 5 more accurately represents the flexible structure model of a parallelogram 25. The latter comprises four points A, B, C, D. A point A represents the elevation axis 29. The large side AB 51 starting from this point A represents the tube 31. The opposite side CD 52 represents the connecting rod 33, 34. The ends of the tube are modeled by the small sides AC 53, BD 54 of the parallelogram. Each segment 51, 52, 53, 54 allows a degree of freedom in the compression and traction direction. The traction and compression flexibilities of the tube 31 and of the connecting rod 33, 34 are modeled by linear springs 55, 56 of respective stiffnesses k_{tube} and k_{b1}. The parallelogram also comprises a branch BJ 57, the point J belonging to the side AB 53. This branch 57 represents the action of the elevation actuator 35 that controls the elevation movement. This actuator can be a jack or a balancing rod. A linear spring 58, of stiffness kⱼ₁, symbolizes the flexibility of this actuator, in other words, for example, of the rod or of the jack.

FIG. 6 represents a flexible model of all the segments 21 forming the robot. The parallelogram 25 of FIG. 5 is complemented by the articulations joining the consecutive segments 21. Overall, each segment is modeled by:
a spring 61 of stiffness kₜ₁ which represents the torsion of the joint 26 upstream of the rotation axis 24;
a spring 62 of stiffness k_{f1} which represents the deflection of the rotation axis 24;
a spring 63 of stiffness kᵣ which represents the elasticity of the rotation cables 42;
a spring 64 of stiffness kₜ₂ which represents the torsion of the joint 27 downstream of the rotation axis 24;
a spring 65 of stiffness kₜₚ which represents the torsion of the parallelogram 25;
the springs 56, 58, 65 described previously, of stiffness k_{b1} representing the flexibility of the connecting rod, of stiffness kᵢ₁ representing the flexibility of the jack or of the rod and of stiffness k_{tube} representing the flexibility of the tube compressionwise.
   These flexibilities will introduce a deformation of the structure. The direct geometrical model DGM of rotation is obtained as a function of seven generalized parameters φₜ₁, φ_{f1}, θ, φᵣ, φₜ₂, α, φ_{tb} which respectively represent the rotation angles of the springs 61, 62 of stiffnesses kₜ₁, k_{f1}, the rotation angle about the rotation axis, the rotation angles of the springs 63, 64 of stiffnesses kᵣ, kₜ₂, the rotation angle about the elevation axis, and the rotation angle of the spring 65 of stiffness kₜₚ.

To calculate the rotation DGM, a homogeneous transformation matrix (4×4) denoted A is for example used. This matrix is a function of the generalized parameters and of the configuration of the robot. It is written in the following form:

$$A ( angle ) = [ \begin{matrix}R ( angle ) & T \\ 0 ( 1 \times 3 ) & 1\end{matrix} ] \qquad ( 1 )$$

in which:
the parameter angle represents one of the generalized parameters φₜ₁, φ_{f1}, θ, φᵣ, φₜ₂, α, φ_{tb};
R is a rotation matrix of dimension (3×3);
T is a translation vector of dimension (3×1);
0 is a zero vector of dimension (1×3).
   The rotation MGD, represented by a matrix Aᵣ, is then calculated according to the following relation:

Aᵣ=A(φₜ₁)×A(φ_{f1})×A(θ)×A(φᵣ)×A(φₜ₂)×A(α)×A(φ_{tb}) (2)

FIG. 7 shows the deformation of the parallelogram structure 25 under the influence of the compression and traction forces originating from the weight of the segments 21 that follow it. The DGM of the parallelogram gives the position and the orientation of the posterior end piece BD in the system of coordinates of the base of the parallelogram at the point A. This calculation is geometrical and is performed in a plane, the plane of the parallelogram. The DGM of the parallelogram, represented by a homogeneous transformation matrix Aₚ, is calculated as a function of three generalized parameters, the abovementioned elevation angle α and the lengths l_{tube} of the tube and l_{connecting rod} of the connecting rod.

The DGM of a segment is the combination of the MGD of the parallelogram 25 and the MGD of the rotation axis 24. The combination of the two DGMs is obtained by a matrix multiplication of the corresponding homogeneous matrices Aᵣ, Aₚ. The matrix representative of the DGM of a segment of order i is therefore obtained by the following relation:

A_{segmenti}=Aᵣ×Aₚ (3)

The DGM of the complete chain representing a robot is obtained by combining the N segments of the chain, the matrix representative of the assembly A_{robot} being given by the following relation:

A_{robot}=A_{segment1}×A_{segment2}× . . . ×A_{segmentN} (4)

The aim of the flexible model is notably to provide the position and the orientation of the effector 22 as a function of the articular positions imposed and of the following parameters:
the weight, the length and the position of the center of gravity of the segments 21;
the stiffnesses k of the various parts of the robot and of the generalized parameters.

In the step 1 of calculating the flexible model, a priori nominal values are assigned to the parameters k. One aim of the following steps is to define the values for real robots, from the a priori nominal values.

This initial flexible model can therefore be obtained by an iterative process. The article by W.Khalil and E. Dombre entitled “Modelisation, identification et commande des robots” [Modeling, identifying and controlling robots] describes such an iterative process. In the present step 1 of the method according to the invention, the calculation method can nevertheless differ and therefore the iterative process can differ.

FIG. 8 illustrates this iterative process used, for example, in the first step 1 of the method according to the invention. The calculation begins, for example, with a rigid model. For a set of configurations 81 and by using the generalized parameters 82 and the geometrical properties of the structure 83, the DGM 84 of the robot is calculated. By introducing the flexibilities of the structure and the imposed gravity effect 85, the forces applied to the parallelograms 25 and the rotation axes 24 are calculated, which makes it possible to model the deformations 86. These deformations 86 are, thereafter, used to update the generalized parameters 87 of the robot and are compared 88 to the old values 82.

If the difference ΔP between the new and the old generalized parameters is less than a given threshold ε, the flexible model 90 is obtained, from the updated DGM 89 and from the new generalized parameters 87. Otherwise 80, a new iteration is executed, this iteration rectifying the old model 84 by using the new generalized parameters. This algorithm is repeated until convergence is obtained. Approximately three to four iterations may be necessary to obtain a difference less than 10⁻⁶ meters or radians between the different generalized parameters.

The flexibility of the articulations 24, 26, 27 and of the bodies 25 of the robot has a significant impact on the performance of the latter regarding the positioning accuracy of the effector 22, and on the stability of this position. The gravity effect and the load at the end of each segment 21 provokes a deviation of the flexible articulations, which degrades the performance of the robot. For robots of large dimensions, notably, the flexibilities that have already been taken into account in the calculation of the model are calibrated in the following two steps 2, 3.

The second step 2 therefore comprises a phase of calibrating the flexible model obtained in the first step 1. The calibration process minimizes a quantity Xₘ−X_{C}. A quantity X can be a vector with six components including three translation components and three rotation components. Such a quantity determines the displacement of a point in space, in this case the positions of the parallelograms or the position of the effector 22.

Xₘ is the measured position from the articulations of the parallelograms and of the effector. The selection of the measurements is notably a function of the application, of the measurement means and of the desired accuracy. This measured position Xₘ can therefore represent either the position of the effector 22, or the position of the intermediate articulations.

The position X_{C} is the position calculated by the flexible DGM of the robot in the first step 1, for the same articulations and for the effector. X_{C} is a function of the configuration vector q and of the parameter vector p.

The configurations of the system described previously can be represented by the configuration vector q, the components of this vector being the angles of the articulations, or rotation axes, of the robot.

The identifiable parameters of the vector p are notably the weight, the length, the position of the center of gravity, the stiffnesses of the various parts of the robot and the generalized parameters described previously. The vector X_{c} can therefore be written according to the following relation:

X_{C}=f(p,q) (5)

in which:

f(p,q)=A₁.A₂ . . . Aᵢ . . . A_{N}.X_{N} (6)

X_{N} being the position of the effector 22 relative to the last segment, the segment of order N, this position is easy to determine. Aᵢ is the homogeneous transformation matrix associated with the segment of order i described previously relative to the relation (1).

By using, for example the vector p₀ of the parameters, p₀ having been used in the first step as representing the parameters given by the constructor of the robot, the nominal position X₀ is obtained. Also by using the rigid vector p_{rigid} of the parameters, the position X_{rigid} is obtained for a certain number of configurations. In this vector p_{rigid}, only θ and α are variable. The other generalized parameters, relating to flexibility, φₜ₁, φ_{f1}, φᵣ, φₜ₂, φ_{tb} have a value equal to 0 and all the stiffnesses k have an infinite value, which would be the case with a perfectly rigid system. One aim is to determine the vector pₒₚₜ of the parameters that minimizes, for example in the least squares sense, the position error Xₘ−X_{C} for a sufficient number of configurations, Xₘ being imposed as intrinsically linked to the robot to be calibrated. The nominal values p₀ of the parameters are used as a starting point for an optimization algorithm used. A used optimization algorithm can be, for example, the nonlinear optimization algorithm described in the article by T. F. Coleman and Y. Li entitled “On the Convergence of Reflective Newton Methods for Large-Scale Nonlinear Minimization Subject to Bounds” in Mathematical Programming, Vol. 67, Number 2, 1994, pages 189-224.

The third step 3 complements the preceding step with the application of a generalized polynomial calibration. The kinematics of the robot are notably defined by the systems of coordinates linked to the base 28 of the robot, to the various segments 21 and to the effector 22. The transition from one system of coordinates to another is obtained by homogeneous transformation matrices Aᵢ that are notably a function of the configuration and of the parameters of the robot.

Without error correction, the position of the effector relative to the base of the robot X_{C1} is therefore calculated according to the following relation:

X_{C1}=A₁.A₂× . . . A_{N}.X_{N} (7)

in which X_{C1} is the flexible position of the effector 22 relative to the base of the robot, calculated in the second step 2. This vector represents an ideal position calculated from the flexible model of the robot obtained in this step 2. As previously, X_{N} is the vector representing the position of the effector relative to the last segment and Aᵢ, i being equal to 1, 2, . . . N, is the flexible homogeneous transformation matrix of the articulation of order i.

To correct the position error, generalized error matrices Eᵢ are inserted between each homogeneous transformation matrix Aᵢ. Generalized error matrices are notably described in the article by M. Meggioalaro, S. Dubowsky and C. Mavroidis entitled “Geometric and elastic error calibration of a high accuracy patient positioning system” in Mechanism and Machine Theory, vol. 40, 2005, pages 415-427. To obtain the new position X_{C2}, the relation (7) is therefore corrected to obtain the following relation:

X_{C2}=A₁.E₁.A₂.E₂ . . . A_{N}.E_{N}.X_{N} (8)

X_{C2} is the real position of the effector relative to the base of the robot and Eᵢ is the generalized error matrix that follows the homogeneous transformation matrix Aᵢ associated with the segment of order 1.

The generalized error matrices Eᵢ are notably intended to correct the angular position error of the rotation axes of each segment. In particular for the articulation of the segment of order i, the matrix Eᵢ allows for the transition from the flexible ideal system of coordinates to the real system of coordinates.

FIG. 9 illustrates the transitions between systems of coordinates. In particular, FIG. 9 presents a system of coordinates 91 linked to the segment of order i−1 having its center at a point Oᵢ₋₁ of the segment. The transformation matrix Aᵢ allows for the transition from the system of coordinates 91 linked to the segment of order i−1 to the system of coordinates 92 linked to the segment of order i having its center at a point Oᵢ of this segment. Then, the generalized error matrix Eᵢ allows for the transition from this ideal system of coordinates to a real system of coordinates 92′, through the combination of a translation movement and a rotation movement, the translation notably causing the system of coordinates to change from the center Oᵢ to a center Oᵢ′.

The elements of each matrix Eᵢ are a nonlinear function of the six generalized parameters ε₁, ε₂, ε₃, ε₄, ε₄, ε₆, three of these parameters ε₁, ε₂, ε₃ representing the Euler angles corresponding to the rotation movement, the other three parameters ε₄, ε₄, ε₆ representing a translation in space. Each generalized parameter is a polynomial function of the geometry of the multiply-articulated system forming the robot and therefore of the configuration vector q.

According to the invention, the matrices Aᵢ represent the flexible model of the robot and the matrices Eᵢ are nonlinear as a function of the generalized parameters. In particular, the matrix Eᵢ can be written in the following form:

$${E}_{i} = [ \begin{matrix}C {ɛ}_{4} C {ɛ}_{6} - S {ɛ}_{4} S {ɛ}_{5} S {ɛ}_{6} & - C {ɛ}_{4} S {ɛ}_{6} - S {ɛ}_{4} C {ɛ}_{5} C {ɛ}_{6} & S {ɛ}_{4} S {ɛ}_{5} & {ɛ}_{1} \\ S {ɛ}_{4} C {ɛ}_{6} + C {ɛ}_{4} C {ɛ}_{5} S {ɛ}_{6} & - S {ɛ}_{4} S {ɛ}_{6} + C {ɛ}_{4} C {ɛ}_{5} C {ɛ}_{6} & - C {ɛ}_{4} S {ɛ}_{5} & {ɛ}_{2} \\ S {ɛ}_{5} S {ɛ}_{6} & S {ɛ}_{5} C {ɛ}_{6} & C {ɛ}_{5} & {ɛ}_{3} \\ 0 & 0 & 0 & 1\end{matrix} ]$$

in which Cεᵢ represents the cosine of the Euler angle εᵢ and Sεᵢ its sine.

Notably because of the parallelogram structure, the flexible model of the robot presents a redundancy in its parameters. There are parameters that are a function of other parameters of the model. Only the independent parameters are identified. The gradient of the objective function defined by the relation (7) can be developed to eliminate the dependency of the parameters. It also makes it possible to increase the robustness of the optimization method. One optimization method used can be the nonlinear least squares method, the algorithm used being the algorithm described in the article by T. F. Coleman et al.

For a given set of configurations, the gradient of the objective function becomes a matrix W in which the number m of configurations is greater than the number of parameters to be identified. The breakdown of the matrix W gives a higher triangular matrix R. The independent parameters are, for example, found by using the diagonal elements r of the triangular matrix R that satisfy the following relation:

r>mxmax(|Rᵢᵢ|)xε (9)

in which Rᵢᵢ is a vector formed by the diagonal elements of the matrix R and ε is the accuracy of the machine required for the system, |Rᵢᵢ| being the modulus of the vector. This method of eliminating parameters is very accurate, in particular it targets only the redundant parameters. It is carried out numerically and is very quick to execute.

Advantageously, the solution proposed by the invention provides a method with which to best correct the position error on large robots but also on small robots. In particular, the invention can be applied to all types of manipulator robots or flexible systems.

1. A method of calibrating the position of a multiply-articulated system consisting of a chain of N segments interlinked by an articulated link, the calibration minimizing the difference between the measured position Xₘ of a member linked to the last segment of the chain and its calculated position X_{C}, X_{C} being equal to the product A₁.A₂ . . . Aᵢ . . . A_{N}.X_{N}, a homogeneous transformation matrix Aᵢ being associated with each segment of order i, this matrix being a function of configuration parameters of the system and of given generalized parameters characterizing the flexibility of the segment, said method comprising:
a first step of calculating a flexible model of the system consisting of the matrices A₁, A₂ . . . Aᵢ . . . A_{N};
a second step of calibrating the flexible model by obtaining a set of generalized parameters (pₒₚₜ) minimizing the difference between Xₘ and X_{C};
a third step of generalized polynomial calibration of the flexible model by the introduction of generalized error matrices Eᵢ between the homogeneous transformation matrices in the flexible model, the calculated position X_{C} being equal to the product A₁.E₁.A₂.E₂ . . . A_{N}.E_{N}.X_{N}, a generalized error matrix Eᵢ being associated with each segment of order i, each matrix Eᵢ of a segment being a polynomial function of the configuration parameters linked to the segment.

2. The method as claimed in claim 1, wherein in the first step the flexible model of the system is obtained by the determination of new generalized parameters from the rigid parameters of the system according to an iterative process:
a geometrical model is calculated as a function of configuration parameters, of original generalized parameters and of geometrical properties of the system;
deformations of the system are calculated as a function of the geometrical model and of mechanical stresses;
new generalized parameters are calculated as a function of the deformations;
the new generalized parameters are compared to the original parameters;
if the difference ΔP between the new parameters and the original parameters is less than a given threshold ε, the flexible model is obtained from the new generalized parameters;
otherwise, a new iteration is executed, this iteration rectifying the model by using the new generalized parameters.

3. The method as claimed in claim 2, wherein the mechanical stresses include flexibility stresses belonging to the generalized parameters.

4. The method as claimed in claim 1, wherein the configuration parameters include the angles of the rotation axes and of elevation relative to a given reference.

5. The method as claimed in claim 1, wherein a segment is modeled by a parallelogram and a rotation axis being articulated between two joints, a first joint belonging to the segment and the second joint belonging to the next segment in the chain, the parallelogram modeling an elevation movement about an axis passing through a peak of the parallelogram, the segment being subject to torsion, compression and traction stresses.

6. The method as claimed in claim 5, wherein each segment is modeled by the following flexibility parameters:
a spring of stiffness kₜ₁ which represents the torsion of the joint (26) upstream of the rotation axis;
a spring of stiffness k_{f1} which represents the deflection of the rotation axis;
a spring of stiffness kᵣ which represents the elasticity of a rotation movement transmission element;
a spring of stiffness kₜ₂ which represents the torsion of the joint downstream of the rotation axis;
a spring of stiffness kₜₚ which represents the torsion of the parallelogram;
springs of stiffness k_{b1} representing the flexibility of a side of the parallelogram, of stiffness k_{tube} representing the flexibility of the opposite side and of stiffness kⱼ₁ representing the flexibility of a branch linking a point (J) of the adjacent side to an end of this side;
a rotation model being obtained as a function of the generalized flexibility parameters φₜ₁, φ_{f1}, θ, φₜ₂, α, φ_{tb} respectively representing the rotation angles of the springs of stiffnesses kₜ₁, k_{f1}, the rotation angle about the rotation axis, the rotation angles of the springs of stiffnesses kᵣ, kₜ₂, the rotation angle about the elevation axis, and the rotation angle of the spring of stiffness kₜₚ.

7. The method as claimed in claim 5, wherein a segment comprising a tube fitted with a connecting rod and provided at each end with a joint, a first joint being articulated about the joint of the next segment through the intermediary of the rotation axis, the rotation movements being obtained by means of rotation pulleys driving a rotation cable, one side of the segment models the tube, the opposite side models the connecting rod, the branch models a balancing element and the rotation movement transmission element models the rotation cable.

8. The method as claimed in claim 1, wherein a generalized error matrix Eᵢ associated with a segment is a nonlinear function of six parameters ε₁, ε₂, ε₃, ε₄, ε₄, ε₆, three of these parameters ε₁, ε₂, ε₃ representing the Euler angles corresponding to the rotation movement of a system of coordinates linked to the segment, the other three parameters ε₄, ε₄, ε₆ representing a translation in the space of the center Oᵢ of the system of coordinates, each generalized parameter is a polynomial function of the components of the configuration vector.

9. The method as claimed in claim 8, wherein the matrix Eᵢ is written in the following form:
$${E}_{i} = [ \begin{matrix}C {ɛ}_{4} C {ɛ}_{6} - S {ɛ}_{4} S {ɛ}_{5} S {ɛ}_{6} & - C {ɛ}_{4} S {ɛ}_{6} - S {ɛ}_{4} C {ɛ}_{5} C {ɛ}_{6} & S {ɛ}_{4} S {ɛ}_{5} & {ɛ}_{1} \\ S {ɛ}_{4} C {ɛ}_{6} + C {ɛ}_{4} C {ɛ}_{5} S {ɛ}_{6} & - S {ɛ}_{4} S {ɛ}_{6} + C {ɛ}_{4} C {ɛ}_{5} C {ɛ}_{6} & - C {ɛ}_{4} S {ɛ}_{5} & {ɛ}_{2} \\ S {ɛ}_{5} S {ɛ}_{6} & S {ɛ}_{5} C {ɛ}_{6} & C {ɛ}_{5} & {ɛ}_{3} \\ 0 & 0 & 0 & 1\end{matrix} ]$$
Cεᵢ representing the cosine of the Euler angle εᵢ and Sεᵢ its sine.
